(19) United States
(12) Patent Application Publication
(10) Pub. No.: US 2004/0181448 A1
(43) Pub. Date: Sep. 16, 2004

(54) Marketing network

(76) Inventors: Paul Hartsman, Richmond Hill (CA); Michael Kogan, Richmond Hill (CA); Yury Lukach, Yekaterinburg (RU)

Correspondence Address: MARKS & CLERK, 1075 NORTH SERVICE ROAD WEST, SUITE 203, OAKVILLE, ON, L6M 2G2, CA

(21) Appl. No.: 10/387,447

(22) Filed: Mar. 14, 2003

(51) Int. Cl. G06F 17/60

(52) U.S. Cl. 705/14; 705/10

(57) ABSTRACT

A system, apparatus and method for providing a marketing network. A server is operable to communicate a set of marketing messages received from a marketing entity to a set of clients via a communications medium for display via the client. The clients can either be a software application, a computing device or any other client that is operable to receive messages from the server and present them visually to a user of the client. The messages are received by the clients and are presented in at least a portion of a display region associated with the client. Where the client includes an input interface, the client can be operable to communicate feedback information to the server.

### FIELD OF THE INVENTION

The present invention relates generally to a marketing network, and more particularly relates to a system, method and apparatus for providing a marketing network.

### BACKGROUND OF THE INVENTION

Companies have generally relied on advertising as a means to market their products and services and develop brand awareness. At first, advertising consisted of signs, posters and bills displaying the product or service and the company providing it. The advent of modern media, communications and transportation have opened opportunities for companies to market their products or services to a larger audience than was previously possible. As a result, more companies are directing their marketing efforts to a global market and spending a larger portion of their budget on marketing.

As used herein, marketing refers to the identification of the particular wants and needs of a target market of customers, and the satisfaction of those customers in a better way than the competitors. Marketing involves the performance of research on customers, the analysis of their needs, and strategic decisions about product/service design, pricing, promotion and distribution. Marketing includes branding, or the process of building up customer awareness of a company or its products/services. Advertising as used refers to the segment of marketing relating to the activity of publicizing a company's name, products and/or services to build customer awareness and the desirability of the company's products and/or services.

Many companies are now looking to revenue generated from the advertising of other companies' products and services generally as a means to finance the delivery of content, services and products. Thirty second commercial spots are sold to advertisers to fund a television program being aired. Likewise, the rights to advertise on various visual elements of a sporting event, such as player jerseys, sideline billboards and scoreboard areas, are being used to pay the high salaries sports athletes demand. Generally, the public has been tolerant of these methods of marketing as the public has not viewed them as being unreasonably invasive.

More recently, with the advent of the Internet, online advertising has been looked to as a means to finance the provision of content, services and products. Among the various forms of online advertising are email marketing, web marketing and advertising, and application-based advertising.

Initially, email marketing was principally subscription-based; that is, a user would subscribe to receive email notifications of product or service updates (typically, where the user subscribed as part of the registration process for a product or service), and/or related products and services (either from the company with which the subscription was placed or one of its business partners). Upon registration, a user would provide one or more pieces of personal information, including an email address. Companies were quick to realize the potential value of the lists of subscribers of their email notification services and began to sell their email address lists to other companies, which, in turn, emailed unsolicited marketing emails (commonly referred to as “spam”) to the email addresses on the lists. Quickly, a business grew around the acquisition and selling of email address lists, whereby companies would use various additional methods for obtaining email address lists including scanning newsgroups and websites for the email addresses of users posting comments. While companies were able to establish a target market through the compilation of a subscribing user email address list, the information sent in the emails typically was not of immediate interest to most of the subscribing users and there was little incentive for the users to read or view the contents of the email. Further, the escalation of unsolicited email from various companies diluted the email marketing market and users were more quick to delete emails deemed to be of a marketing nature without reading or viewing them. Spam-blocking software and Internet service providers providing spam-blocking services have become popular, thus reducing the effectiveness of both solicited and unsolicited email marketing campaigns. As a result, relatively little opportunity is available for a company to market via email.

Web marketing made its debut in 1994 with the rise in popularity of the Internet. Companies established and maintained websites to provide information about their products and services and offer sale thereof. Further, content providers, such as magazines and newspapers, developed websites through which content, sometimes limited, was provided and subscription to a periodical was offered. While these sites were useful, they did not generate the traffic desired and already achieved by various other content and service providers, such as search engine websites, which attracted users with content and/or functionality. These content and service providers quickly identified and exploited this market by introducing banner advertisements that advertised the name and products of other companies and allowed a user to click on them to be directed to additional content associated with the advertised product or service.

Shortly thereafter, a number of dedicated Internet advertising agencies were established, offering these sites the management of the web advertising. These agencies quickly realized that, by using a feature of web browsers known as “cookies”, they could collect information about the behavior of users. Cookies were devised to be a convenient way for the operator of a website to store either personal or generic information about a user without requiring a user to create an identity and password combination and log on to a website. They are small text files stored on a web browser user's computer that are generally accessible only by computers belonging to a specific Internet domain, (for example, nytimes.com) such that when a user accesses a website, the user's computer sends the cookie associated with that website (if one exists on the user's computer) to the server implementing that website.

The website, in turn, could manage and update the cookie stored on the user's computer to reflect any further information collected from the user's browsing behavior or provided information. While the user is visiting different websites, these different websites can pull in content (i.e. advertisements) from the same Internet advertising agency via a single Internet domain, allowing the agency to associate information collected from the user's behavior with the advertisement displayed on abc.com's website with his behavior with the advertisement displayed on def.com's website, as both websites have embedded links to content stored on the Internet advertising agency's domain (e.g. ghi.net). Advertising companies quickly learned that they could track, among other information, a user's preferences and develop a profile for the user by storing information about which advertisements the user clicked on. With time and additional functionality being offered by web browsers, advertising companies were able to associate the information collected about a user with other information gathered from other sources, such as an associated website.

Increasing public awareness of these practices in recent years led to increasing public intolerance of this practice of collecting information, even where the information being collected was not personally identifying a user. As a result, Internet advertising agencies and other companies began to develop privacy policies and post them on their website to indicate to users what information was being collected, why it was being collected, how it would be stored and used, how long it would be stored and to whom would the information be provided, if anyone. Even when disclosed, however, the practice of collecting information and compiling profiles for users was not generally viewed as fair practice by the public.

Further, increased competition in web advertising has led to new, more invasive methods of delivering advertisements, including pop-up ads that appear in a new browser window when a certain webpage is viewed, even “popping up” a new ad once the original pop-up ad is closed, pop-under ads that effectively display an ad in a new browser window placed underneath the browser window currently being viewed, blind ads that appear and disappear like a pull-down window blind, and even animated banner ads alerting users of prizes that may purportedly have been already won.

As a result, the public has been decreasingly receptive to and increasingly distrustful of web advertising and marketing. Further, there exist a number of readily available software and hardware applications, enabling users to hinder or block web advertising and reduce their effectiveness. Another disadvantage of this method of advertising and marketing is that the public's fascination with the Internet and websites is waning, resulting in decreased willingness to return on a regular basis to a specific website and the gradual loss of the target audience.

Some of the foregoing problems have been addressed by the introduction of client-based advertising. A software or hardware client is distributed at a reduced, or no, cost to the user, with a portion of the client interface being dedicated to displaying advertising from a number of sponsors of the application. As the client is for a specific function, companies selling products or services associated with the functionality can sponsor the client and, in return, are allowed to provide advertisements to be displayed in the advertising area of the client display interface. A disadvantage of this approach is that the public is distrustful of providing any information and generally unreceptive to the advertising displayed.

Another disadvantage of web advertising is that advertising or marketing messages can only be delivered to a user when the user is accessing the website upon which the message is displayed. Even if a website has a large constituency of users who return on a daily basis, advertising and marketing messages can only be displayed for the brief period of time during which the user is viewing the pages on the website.

One method adopted by The Gator Corporation to retain a “captive” audience is to freely distribute a software client that has a desirable set of functionality tied to a messaging agent that runs as a background process. For example, the free software offered by Gator^{SM} can be, in one case, a calendar accessible through the tasktray of the Microsoft® Windows® family of operating systems. The application includes a discrete agent that watches the webpages being viewed by the user and can trigger pop-up ads and links to advertisers' websites that are associated with the webpage being viewed. Despite the functionality provided by the various clients offered by Gator, users are generally unwilling to tolerate either the pop-up ads invoked by the software client or the collection of personal information performed by the software client.

Accordingly, there is a need for a system, apparatus and method of delivering advertising that is tolerated and trusted by a user and that encourages the user to remain open to receiving marketing messages for as much time as possible.

### SUMMARY OF THE INVENTION

In an aspect of the invention, there is provided a marketing network system, comprising: a server having storage means for storing at least one marketing message, at least one processor operable to generate at least one data transmission from the at least one marketing message from a marketing entity, and a server network interface connected to a communications network and operable to transmit the at least one data transmission across the communications network; and at least one client having a client network interface connected to the communications network, processing means and a display interface for displaying a graphical user interface (GUI), the at least one client providing a first set of functionality operable to display output information via the GUI, and a second set of functionality operable to receive the at least one data transmission from the server via the network interface, generate the at least one marketing message from the at least one data transmission and present the at least one marketing message to the user via at least a portion of the GUI.

In a particular implementation of the first aspect, the marketing entity is a public company.

In another particular implementation of the first aspect, the server is operable to selectively transmit the at least one marketing message to the client based on at least one message rule. The message rules can be based on quota criteria, time criteria, location criteria, demographics criteria, etc.

The server can be operable to maintain a profile for the user of the client, wherein at least one of the at least one message rule is at least partially based on the profile, and wherein the profile is at least partially comprised of personal data provided by the user.

The client can be distributed freely or at reduced cost, can be a software application, and can also be a computing device.

In a particular implementation, the server can be operable to detect a communication limitation of the client network interface and the communications network and selectively adjust at least one of the at least one marketing message before generation of the at least one data communication. Further, the server can be operable to detect a display limitation associated with at least one of the GUI and the display interface of the client and selectively adjust at least one of the at least one marketing message before generation of the at least one data communication.

In another implementation of the first aspect, the client additionally has an input interface and the at least one marketing message allows the user to provide feedback to the server via the client network interface, and the server is operable to receive and record the feedback received from the client and selectively transmit the messages at least partially based on the feedback.

The at least a portion of the GUI can be a variable portion of the GUI, which can be controlled by the server.

In a second aspect of the invention, there is provided a software client for providing a marketing network, comprising: a graphical user interface (GUI) for presentation on a display associated with a computing device upon which the software client is executed, the GUI having a first display region and a second display region; a first set of functionality being presented via the first display region of the GUI; a network interface operable to receive data communications containing at least one marketing message from a marketing entity via a communications network connected to the computing device; and a second set of functionality operable to receive the data communications, generate the at least one marketing message from the data communications and present the at least one marketing message in the second display region of the GUI.

In an implementation of the second aspect, the software client additionally comprises an input interface operable to allow a user of the software client to interact with the second set of functionality, and at least one of the at least one marketing message allows the user to provide feedback via the network interface.

The second display region can be a variable portion of the GUI, which can be controlled by the at least one marketing message.

In a third aspect of the invention, there is provided a server for operating a marketing network, comprising: a central processing unit (CPU), a data storage device for exchanging non-volatile data with the CPU, random access memory (RAM) for exchanging volatile data with the CPU, and a network interface for sending and receiving data communications; the network interface being operable to receive at least one marketing message from at least one marketing entity; the CPU and RAM being operable to store the marketing messages in a message database; and the CPU being operable to retrieve the at least one marketing message associated with one of the marketing entities from the database and transmit the at least one marketing message associated with one of the marketing entities via the network interface to at least one client associated with the one of the marketing entities.

In a particular implementation of the third aspect, the network interface can be operable to receive a set of rules associated with the at least one marketing message, wherein the CPU is operable to store the set of rules in the message database, analyze the set of rules, and selectively direct the network interface to transmit the at least one marketing message to the at least one client associated with the one of the marketing entities based on the set of rules.

The CPU can be operable to receive client information associated with each of the at least one client via the network interface and is operable to store the client information in the database. The client information can be at least partially comprised of personal data provided by a user of the client.

The CPU can also be operable to receive feedback via the network interface from the at least one client, and record the feedback received from the at least one client in the database.

In another implementation of the third aspect, the CPU can be operable to maintain client statistics in the database and generate a statistical report from the client statistics.

In a fourth aspect of the invention, there is provided a method for providing a marketing network, comprising the steps of: distributing a client having a display interface for displaying a graphical user interface (GUI), a network interface connected to a communications network and operable to receive data communications, and a processing means, the client providing a first set of functionality operable to display output information via the display interface and a second set of functionality operable to receive the data communications from the network interface, process the data communications via the processing means and present messages contained in the data communications via at least a portion of the GUI; receiving at least one message from a marketing entity; and, communicating the data communications containing the messages from a marketing entity across the communications network to the client for presentation via the display interface.

The provision of the first set of functionality to the user can be subsidized by the marketing entity providing the messages to the user via the second set of functionality.

The method can additionally include, before the transmitting step, the steps of receiving at least one rule associated with the messages; and, determining whether the client is to receive the messages based on the at least one rule. The rules can be based on a quota for the messages, a time period, and the geographic location of the client or a number of other factors and any combinations thereof.

The step of determining can be at least partially comprised of comparing the at least one rule with a profile maintained for the client. The profile can be at least partially comprised of personal data provided by the user.

The client can be a software client or a computing device.

In a particular implementation of the fourth aspect, the method includes, before the communicating step, the steps of: detecting a communication limitation of the network interface and the communications network; and selectively adjusting the message for the communication limitation.

In another particular implementation of the fourth aspect, the method further comprises, before the communicating step, the steps of: detecting a display limitation associated with at least one of the GUI and the display interface of the client; and selectively adjusting the message for the display limitation.

Where the client additionally has an input interface and at least one of the at least one message allows the user to provide feedback to the marketing entity via the network interface, the method can further comprise, after the communicating step, the steps of: receiving and recording the feedback from the user; and selectively communicating the data messages at least partially based on the feedback.

### BRIEF DESCRIPTION OF THE DRAWINGS

Preferred embodiments of the present invention will now be described, by way of example only, with reference to the attached Figures, wherein:

FIG. 1 shows a block diagram of the system in accordance with the invention;

FIG. 2 shows a number of physical elements of the server, in accordance with an embodiment of the invention;

FIG. 3 shows a number of logical components of the client, in accordance with an embodiment of the invention;

FIG. 4 shows a particular embodiment of the invention;

FIG. 5 shows a method of providing a marketing network in accordance with an embodiment of the invention;

FIG. 6 shows a graphical user interface for a software client in accordance with an embodiment of the invention;

FIG. 7 shows a method of providing a marketing network in accordance with an embodiment of the invention;

FIG. 8 shows a method of providing a marketing network in accordance with an embodiment of the invention;

FIG. 9 shows a method of providing a marketing network in accordance with an embodiment of the invention; and

FIG. 10 shows a computing device client in accordance with an embodiment of the invention.

### DETAILED DESCRIPTION OF THE INVENTION

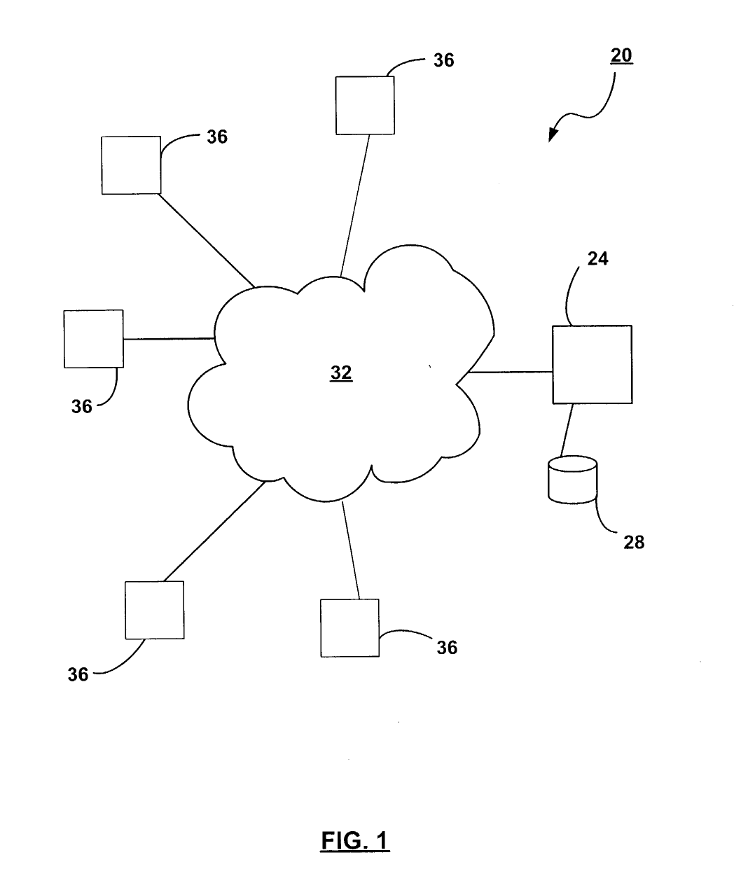

A system for providing a marketing network in accordance with an embodiment of the invention is generally shown at 20 in FIG. 1. In the present embodiment, system 20 is comprised of a server 24 accessing a database 28 and coupled via a communications medium 32 to a number of clients 36.

Server 24 is any server known in the art, and generally includes a central processing unit, random access memory, data storage means, and a network interface to allow server 24 to send and receive communications over communications medium 32. Server 24 can be a single or multiple physical machines coupled together to provide the desired functionality. In an embodiment of the invention, server 24 is a load-balanced server farm. Further, server 24 can be two or more physical machines that collectively provide the same function as a server in a single location, but are topologically distributed over communications medium 32 so that they are able to serve content and data more quickly and reliably to clients at various positions over communication medium 32.

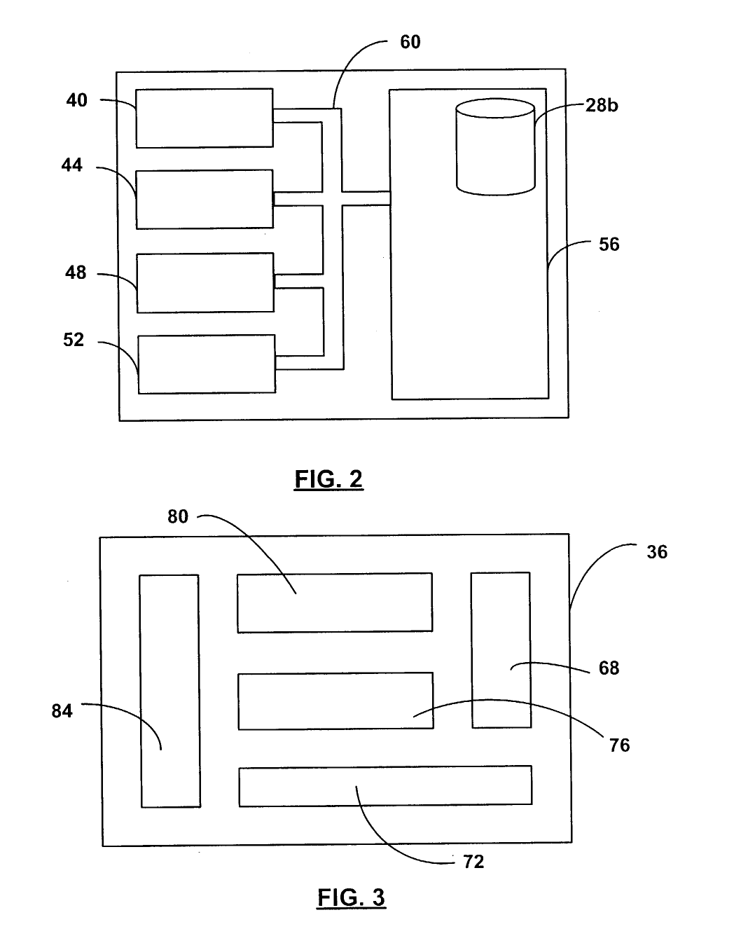

FIG. 2 shows a server in accordance with an embodiment of the invention. The server is comprised of a central processing unit (CPU) 40, random access memory (RAM) 44 for volatile storage, human input/output interface 48 for accepting input and presenting output to a user, network adapter 52 for communication with other networked devices over communications medium 32, and non-volatile storage 56 (such as one or more fixed disks) for storage of persistent data, all connected via bus 60. Additionally shown is database 28b residing in non-volatile storage 56 of the server.

While, in FIG. 2, database 28b is shown resident on non-volatile storage 56 of the server, database 28 can also be located on a database server executing commercial software such as Oracle9i™ Database or Microsoft SQL Server™ or a proprietary platform. Further, database 28 can be located on a number of computers that are distributed over communications medium 32. Where database 28 is located on a physical machine separate from server 24, it is understood by those of skill in the art that database 28 can be directly coupled to server 24, or can be accessible to server 24 via communications medium 32 or another telecommunications network.

In another embodiment of the invention, database 28 is operatively provided by the combination of data stored on data storage means of server 24 and data stored locally on each client 36.

Communications medium 32 can be any telecommunication network or networks known in the art that allows server 24 to send communications to one or more clients 36.

In a present embodiment, communications medium 32 is primarily comprised of the Internet and includes any peripheral networks known to those of skill in the art through which server 24, database 28 and clients 36 connect to the Internet, including, but not limited to, IP-based Ethernet networks such as dial-up service providers, satellite-based networks, wireless networks employing standards such as the IEEE® 802 series and the like, wireless networks implementing CDMA, TDMA, WCDMA and the like, and connected infrastructure.

Clients 36 are connected via communications medium 32 to server 24. For purposes of this discussion, client shall mean any software, hardware or combination thereof that is operable to receive a message communicated by server 24 via communications medium 32 and visually present the message to a user of the client. Clients 36 can be software applications that can be written and compiled to execute on a computing device such as a personal computer, personal digital assistant, a mobile phone, a pager, etc. These computing devices can utilize any of a number of operating systems including Microsoft Windows XP, Microsoft Pocket PC, Palm OS®, Linux, Unix®, Mac IM OS X.1, etc., all of which generally provide networking APIs with which software applications executing thereon can receive and, in some cases, send information to a network.

Clients 36 can be any computing device that is operable to be connected to a communications network and present information visually to a user. Hardware clients can include mobile communications devices such as mobile phones, wireless email devices, personal digital assistants, pagers, and can also include automated teller machines, information kiosks, and the like. The functionality of a hardware client can be provided by software, firmware or a combination thereof.

FIG. 3 shows a number of logical components of client 36. Client 36 has a network interface 68, an input interface 72 (optional), a first set of functionality 76, a second set of functionality 80 and a display interface 84.

Network interface 68 is operable to receive a message sent from server 24 via communications network 32. Where client 36 is a computing device, network interface 68 can be a network adapter such as an Ethernet adapter, a modem, a Bluetooth adapter, an antenna for wireless communications, a synchronization interface for handheld devices, a serial port, etc. Where client 36 is implemented via software, network interface 68 can be a set of program controls for communicating with a network API of an operating system of a computing device upon which software client is executing for at least receiving information from a network connected to the computing device upon which client 36 is implemented. Network interface 68 can be operable to receive information via any number of protocols utilized to communicate over network 32. In a present embodiment, network interface 68 is operable to both send and receive communications.

Input interface 72 is optionally provided and operable to allow a user of client 36 to interact with first set of functionality 76 and second set of functionality 80. Where client 36 is a software application, input interface 72 can be operable to receive input information entered via a keyboard, a keypad, a mouse, touch-sensitive screen, a tableau, input buttons, microphone, or any other means operable to allow a user to interact with the computing device upon which client 36 executes. Where client 36 is a computing device, input interface 72 can be a keyboard, a keypad, a mouse, touch-sensitive screen, a tableau, input buttons, microphone, or any other means operable to allow a user to interact with client 36.

First set of functionality 76 is operable to provide a user with a desirable application. The desirable application can be a self-contained or can be networked. Some examples of such applications include an office application for word processing, a multimedia application for editing photos, a stock ticker, or a game to be played alone or cooperatively with others.

Further, the desirable application can also have a service component. For example, where client 36 is a mobile phone, first set of functionality 76 could allow a user thereof to place and receive phone and/or data calls. Moreover, where client 36 is a computing device with a GPS navigation system, first set of functionality 76 could display a street map of the surrounding area including the position of the client (i.e. the user of the client). Additionally, where client 36 is a software application executed on a personal computer, first set of functionality 76 could provide Voice over IP telephony, enabling a user thereof to place calls via communications medium 32, possibly at a reduced price.

Second set of functionality 80 is operable to receive a message from server 24 via network interface 68 and perform processing of the message before passing the message to display interface 84.

Second set of functionality 80 can additionally be operable to receive input information from a user of client 36 from input interface 72, if client 36 is so equipped, and process the input information. Where second set of functionality 80 determines that the input information comprises feedback information, it provides the feedback information to network interface for communication to server 24.

It is understood by those of skill in the art that first set of functionality 76 and second set of functionality 80 can share common elements and processes and can be interactive.

Display interface 84 is in communication with first set of functionality 76 and second set of functionality 80 and operable to receive instructions for presenting messages to a user of client 36. Where client 36 is a software application, display interface 84 is a set of programming functionality operable to communicate information to the computing device upon which client 36 is executing, typically via an API or like feature for the device. Where client 36 is a hardware device, display interface 84 refers to the API that is operable to allow control of and information to be presented on the physical display of the device.

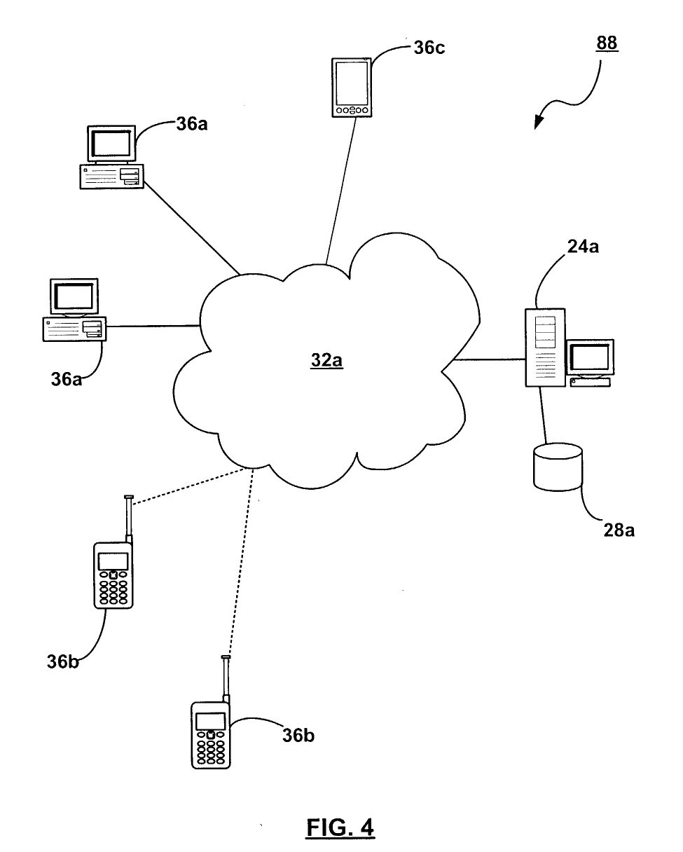

FIG. 4 shows a system generally at 88 in accordance with a present embodiment of the invention. System 88 is comprised of a server 24a accessing a database 28a stored locally on a physical drive of server 24a. Server 24a is in communication with a set of clients 36a, 36b and 36c via communications medium 32a. Communications medium 32a is comprised of the Internet and any peripheral networks used by server 24a and clients 36a, 36b and 36c to connect to the Internet.

Clients 36a are software applications executing on personal computers which are operable to connect to communications medium 32a via direct connection, dial-up or the like. Clients 36b are mobile phones that are operable to connect to the Internet via radio communications with a cell antenna, which is, in turn, connected to the Internet via a wireless service provider's infrastructure. Client 36c is a personal digital assistant operable to connect to communications medium 32a via a serial connection, a synchronization cradle, a wireless network adapter or the like.

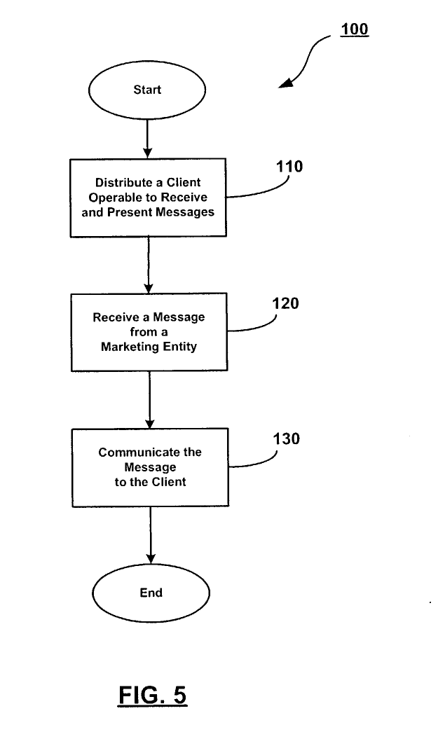

Now referring to FIG. 5, a method of providing a marketing network is shown generally at 100. At step 110, one or more clients 36 that are operable to receive and present messages from a marketing entity are distributed. In one embodiment, clients 36 are software applications that are distributed via CDs enclosed in product packaging, but the software clients can also be distributed via pre-installation on computing devices, email, download from a networked computer, etc. Where client 36 is a computing device, client 36 can be available for purchase/pick-up at one or more sites, such as a store or a promotion booth, it can be mailed to a user upon receipt of a request, etc.

Prior to, during and/or after distribution of client 36 to a user, the user is notified that the distribution is sponsored by a marketing entity. A marketing entity refers to a single company, corporation, group, organization, etc. that wishes to market its own products and/or services or broadcast a statement (such as an anti-drinking and driving campaign). By indicating to the user that all information transmitted to client 36 is from a single marketing entity, and not simply from any company with an advertising budget, user trust can be gained.

Further, where client 36 is operable to collect information from the user, the user is reassured that any information collected is intended for use solely by the identified marketing entity. Information can be collected from the user at one or more of a number of points, including prior to the distribution of client 36, upon activation of client 36 for the first time or shortly thereafter, and during its use through the user's interaction with client 36. The information collected can include, but is not limited to, the time and date of activation of client 36 where client 36 is operable to be activated and deactivated, the geographic location of client 36 (for example, indicated by the user, the network address associated with client 36 or cell tower triangulation, if a mobile device is employed), information regarding the user's interaction with client 36 (including response to various messages presented by client 36 and the discrete collection of information about the user's interaction with client 36), information provided by the user during operation of client 36 and information regarding the user's interaction with first set of functionality 76.

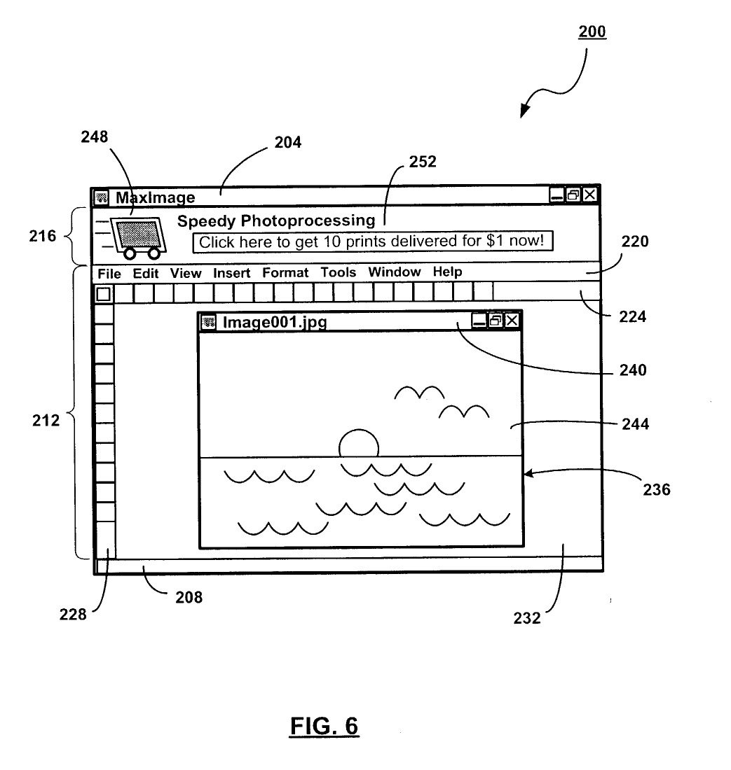

FIG. 6 shows an example of client 36 in accordance with an embodiment of the invention. In this case, the client is a software application for execution on the Microsoft Windows platform having a graphical user interface (GUI) shown generally at 200. GUI 200 is comprised of a number of visual display regions including window title 204, status bar 208, a first display region 212 and a second display region 216. First display region 212 provides a graphical interface via which output information from first set of functionality 76 is presented. In this case, first set of functionality 76 allows a user of software client 200 to edit visual images, similar to the functionality available in commercial software packages such as Adobe® Photoshop®.

First display region 212 is comprised of a menu bar 220, a horizontal toolbar 224, a vertical toolbar 228, and a work area 232. Shown in work area 232 is a document window 236 showing a document currently being edited. Document window 236 is shown having a title bar 240 and an image 244 that effectively comprises the document. By interacting with menu bar 220, toolbars 224 and 228 and document window 236 via an input interface such as a keyboard and mouse, a user is able to edit image 244.

Second display region 216 is shown occupying a portion of GUI 200. In keeping with the present invention, second display region can permanently occupy a set portion of GUI 200. Alternatively, second display region 216 can occupy a variable portion of GUI 200. In such a case, second display region can be operable to be resized to occupy all or a large portion of GUI 200, or none or a small portion of GUI 200.

Second display region 216 is shown being comprised of a marketing logo 248 corresponding to the marketing entity with which software client 200 is associated. Logo 248 can be persistently displayed in second display region 216 or can be displayed only at set times. In a present embodiment, logo 248 is persistently displayed in a set position in the second display region to increase brand recognition. Additionally, a variable information area 252 is shown displaying the name of the marketing entity, “Speedy Photoprocessing” in this case, and a sales promotion currently in effect, in this case an offer for online photoprocessing.

Where the marketing messages to be communicated to a specific client 36 are to be, in any way, customized based on information associated with the specific client 36 or its user, client 36 can be operable to be associated with the information in a variety of ways. In an embodiment of the invention, the user of client 36 provides a set of personal information at registration of client 36 after receiving it. The information provided by the user is received by client 36 via input interface 72 and is recorded by client locally (i.e. on client 36 or the computing device upon which client 36 is executing). Upon each instance of the user's activation of client 36, client 36 communicates its active status to server 24 over communications medium 32 via network interface 68, along with some or all of the information collected from the user. The information can optionally be stored on the computing device and/or communicated over communications medium 32 in an encrypted format such that unauthorized access to the information is impeded.

In another embodiment of the invention, client 36 sends the user-provided information over communications network 32 to server 24 for storage in database 28. Client 36 does not retain a copy of the information transmitted locally, but is instead assigned a unique identification code or number by server 24 that is then stored locally and communicated over communications medium 32 each time client 36 is activated. The identification code is associated with the record of personal information associated with the user of client 36 and, upon receipt of the identification code, is able to then relate client 36 to the user.

In another embodiment, each client is provided a unique identification code, such as a number stored on a Subscriber Identity Module for a mobile phone, and is recorded in database 28, along with personal information provided by users of clients 36 upon registration. Upon an initial communication between client 36 and server 24, server 24 is operable to retrieve information from database 28 associated with client 36.

Referring again to FIG. 5, at step 120, one or more marketing messages are received. Here, the marketing messages are made available to server 24 responsible for communicating the messages to the clients 36. In an embodiment, the messages are transferred to server 24 for storage and distribution, either by communicating the messages to server 24 via a network, by loading the messages on server 24 via a local data interface (such as, for example, an optical drive or USB storage) or by any other method known to those skilled in the art. In another embodiment, Uniform Resource Identifiers (URIs), such as Uniform Resource Locators, are provided to server 24 to embed in messages sent to clients 36, the URIs indicating a separate location for the content. The messages can also be operable to be displayed in the entire area of second display region 216 or only a portion thereof.

The marketing messages can be of any form that provides client 36 the necessary information to display information from the marketing entity, including, but not limited to, images and other multimedia formats, markup language documents, and scripts.

Then, at step 130, the message is communicated to clients 36. Second set of functionality 80 can include a process to request messages from server 24. Alternatively, server 24 can proactively push content to client 36 using any one of a number of methods, including broadcast and “store and forward”. Where server 24 stores the marketing messages from the marketing entity locally, server 24 retrieves a copy of the message from non-volatile storage (that is, a fixed disk) and transmits them via communications network 32 to clients 36. Server 24 can be operable to transmit the marketing message via any one of a number of routing protocols (such as Internet Protocol), any one of a number of transport protocols (such as Transmission Control Protocol), and via any one of a number of user-level protocols (HyperText Transport Protocol). Upon receipt of the communication, client 36 prepares it for display via second set of functionality 80 and presents it to the user via display interface 84.

The communication of these messages can be achieved in a variety of ways. For example, where client 36 is a software application executing on a personal computer operable to be connected to the Internet, client 36 can be operable to automatically detect a connection to the Internet and send a request for updated content/messages to server 24 via network interface 68. Client 36 can additionally send an identifier notifying server 24 of its identity. Upon receipt of this request for updated content from client 36, server 24 communicates one or more messages to client 36 for presentation via display interface 84. Client 36 can immediately present these received messages or can store them for display at a later time, such as when client 36 is not in communication with the Internet. Alternatively, server 24 can detect the availability status of clients 36 by a number of methods known to those of skill in the art, such as sending or receiving detection requests responded to by the recipient (i.e. server 24 or client 36) and responding accordingly.

Once the message has been communicated, method 100 is complete.

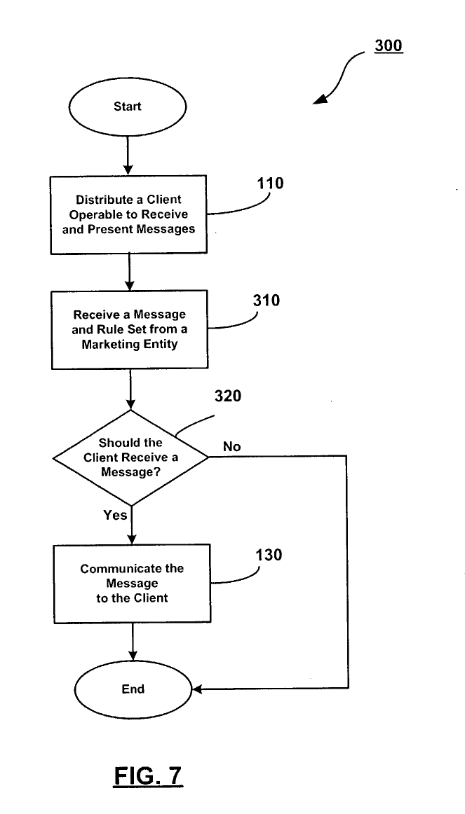

A second method for providing a marketing network is shown generally at 300 in FIG. 7. At step 110, one or more clients are distributed to users. Then, a message from a marketing entity and an associated rule set is received at step 310. The rule set is one or more rules that specify criteria for communicating the message to clients 36. The rules can be based on a number of inputs, including time of day, date, geographic location of a client, demographic information associated with a user of a client or the client itself, a quota for the number of times a message is to be communicated (per user or per group of users, for example), the preferences of a user of the client, etc. The rules in the rule set can be positively or negatively stated, can be expressly declared as a Boolean statement, or can be any other scheme known to those skilled in the art.

Examples of rules include:

each client or user of the client shall not receive the message more than twice,

the message should be displayed a pre-determined minimum number of times,

the message should be communicated to clients located in northern states during the winter months from December to April,

the message should only be transmitted to clients meeting specified requirements, such as having a minimum display size or network connection speed,

the message should be communicated to users who are male, between the ages of 18 and 35 and have an annual salary of less than $50,000, and

the message should be visible for a set period of time (i.e. the marketing entity could specify that a set of messages or a specific message must be visible, not being hidden under another application window, for a pre-determined period of time before the message(s) can be turned off, where this functionality is provided).

Further, server 24 and/or client 36 can be operable to provide conflict resolution where two or more messages are scheduled to be communicated or displayed. For example, where the rules specified for two or more messages indicate that they should be displayed at a specific time, server 24 and/or client 36 could be configured to select one of the messages to display, alternatingly display the messages during the specified period of time, etc.

By providing the mechanism for specifying controls for how the message is communicated, a marketing entity is empowered to manage its marketing efforts as it sees fit.

At step 320, server 24 examines the rule set received at step 310 and evaluates each rule in the rule set until it is determined that a message should be communicated or should not be communicated to client 36. Server 24 can provide such a determination at a number of times, including notification of the active status of a specific client, at a pre-determined or opportune time, etc. The time of determination can depend on the method used to deliver the marketing messages. For example, where a “store and forward” system is used, server 24 can, upon receipt of a message and the set of associated rules, make a determination as to which clients should receive the message and then transmit the message immediately. As clients 36 are connected to communications medium 32, the message is then communicated to them. Alternatively, where the set of rules includes a time or date criterion, server 24 can either immediately determine which clients are to receive the message and queue the message for later delivery or can make a determination at a later time prior to the specified time period(s). Other systems for making such determinations are known to those of skill in the art.

If server 24 determines that client 36 is not to receive the message, the method terminates. Otherwise if server 24 determines that client 36 is to receive the message, the method proceeds to step 130, at which server 24 communicates the message to client 36 over communications medium 32. Again, the communication of the message can be immediate or can be delayed, based on the client's connection to communications medium 32, any time/date criteria, etc. Once the message is communicated to client 36, the method is complete.

Where there is a limitation in the ability of client 36 to receive and display a message from server 24, server 24 can be operable to consider the limitation and adjust or cancel the message in light of the limitation. In a first example, where client 36 has a slow connection to server 24 (either because of a device limitation or because of a connection limitation), server 24 can selectively adjust the size of the message communicated to client 36 and can also selectively not communicate the message to client 36. In a second example, where client 36 has a display limitation (such as a small display screen), server 24 can be operable to selectively reduce the size of the message or can selectively communicate an alternate message, perhaps of a smaller size. Further limitations include processing, memory and input interface limitations of the computing device. Other limitations will be apparent to those skilled in the art.

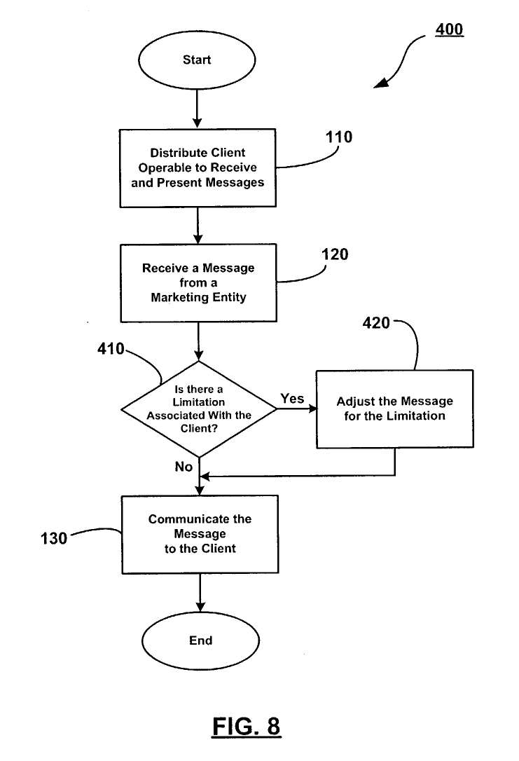

FIG. 8 shows a method of providing a marketing network where such a limitation exists. At step 110, one or more clients are distributed to users. Then, at step 120, one or more marketing messages are received. The method then proceeds to step 410.

At step 410, server 24 determines whether there is a limitation associated with client 36. This can be achieved either via a communication between client 36 and server 24, or can be recorded in database 28 and retrieved as needed. When client 36 is distributed at step 110, client 36 can be provided a unique identification code. This code can be then stored in database 28, along with any known limitations inherent in client 36 (such as a small and/or monochrome display). Additionally, server 24 can determine if client 36 has any limitations via a communication between client 36 and server 24. Client 36 can be operable to transmit any display or other limitations to server. Further, server 24 can determine any limitations of the connection between client 36 and server 24 via a number of methods known to those of skill in the art, including measuring packet loss and ping time.

Where server 24 determines that it needs to modify the message for the limitations determined at step 410, the method proceeds to step 420, at which server 24 adjusts the message for the limitation. Where client 36 has a display limitation, server 24 can be operable to substitute an alternate, smaller message for the message. Similarly, where the connection between client 36 and server 24 has a communication limitation, server 24 can substitute an alternate message for the message (substituting a lower quality image, for example). These modifications to the message can be actively or passively performed by server 24. In one embodiment, database 28 is equipped with two or more associated alternative messages from which server 24 selects a message for communication to client 36. In another embodiment, server 24 degrades the quality and/or size of the message stored in database 28. Other methods of adjusting the message will occur to those of skill in the art.

Then at step 130, server 24 communicates the message to client 36 across communication medium 32. Once the message has been communicated to client 32, the method is complete.

Messages can allow users of client 36 to interact in some manner with them when presented via client 36. In one embodiment, the messages allow a user to retrieve additional information using input interface 72. For example, where client 36 is a software application, client 36 can be operable to open a web browser window linking to a specific webpage or content upon the user's clicking in a certain portion of second display region 216. In another embodiment, the messages include a request for information, such as a survey. It can be desirable to record information from these interactions in database 28.

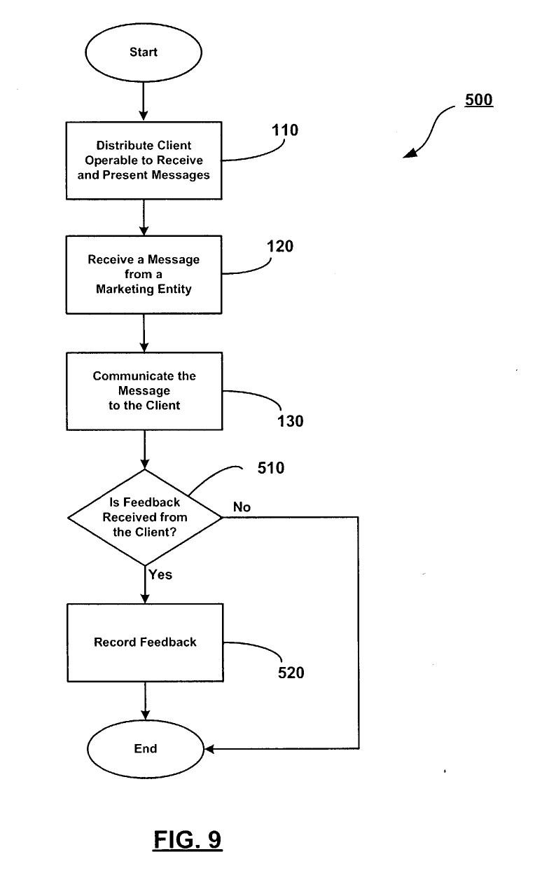

A method for providing an interactive marketing network is shown in FIG. 9. At step 110, one or more clients are distributed to users. Then, at step 120, one or more marketing messages are received. The message is then communicated to client 36 at step 130. The method then proceeds to step 510.

At step 510, server 24 determines whether feedback was received from client 36. Client 36 can be operable to communicate feedback information to server 24 upon an event, such as the user's clicking on a certain area of second display region 216 or the user's indication of his completion of a set of questions presented in second display region 216. Server 24 may not actually receive any feedback information from client 36, either immediately or ever, but server 24 can be operable to receive and store feedback information in database 28 upon receipt thereof at any time.

Client 36 can be operable to receive feedback information from a user of client 36 and store it locally until a later time at which the feedback information is communicated to server 24. This is useful where client 36 is only intermittently connected to communications medium 32, such as is the case with dial-up Internet service.

If and when server 24 receives a communication from client 36 indicating feedback information from the user, the method proceeds to step 520, at which point server 24 records some or all of the feedback information in database 28.

Upon the recording of the feedback information in database 28, method 500 is complete.

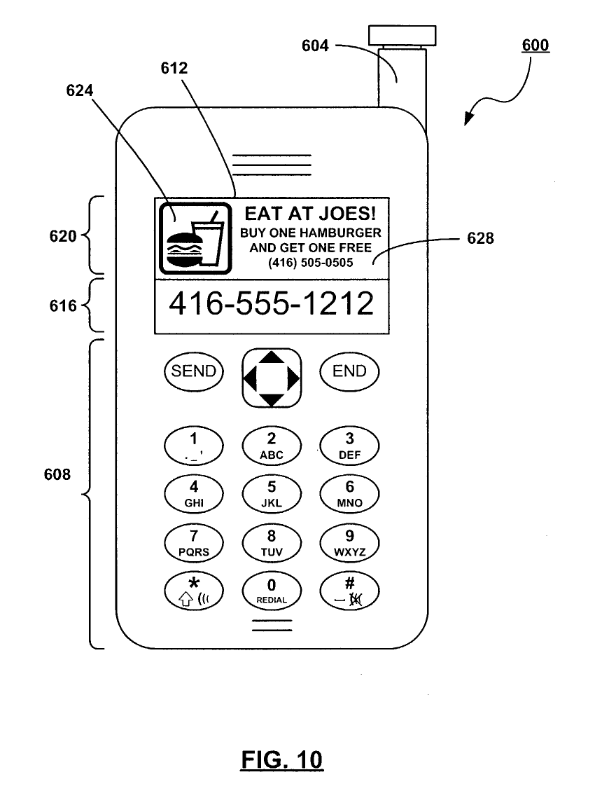

Now referring to FIG. 10, a client that is a computing device in accordance with another embodiment of the invention is shown generally at 600. Computing device 600, a mobile phone in this instance, is comprised of a radio antenna 604, an input interface 608, and a display 612. Radio antenna 604 acts as a network interface and is operable to send and receive wireless network communications. Input interface 608 is comprised of a numeric keypad that is operable to allow a user to enter inputs chosen from an extended alphanumeric collection. Input interface 608 is additionally comprised of a microphone to allow for audio input. Display is comprised of a first display region 616, and a second display region 620. First display region 616 is operable to allow a user of computing device 600 to view various information, such as his inputs. Shown in first display region is a telephone number being dialed by a user of computing device 600. Second display region 620 is operable to present marketing messages from a marketing entity. Shown in second display region 620 are a logo 624 and a text message 628. Text message 628 is shown consisting of a restaurant slogan, a current promotion and the telephone number of the advertising restaurant (that is, the marketing entity).

While the embodiments discussed herein are directed to specific implementations of the invention, it will be understood that combinations, sub-sets and variations of the embodiments are within the scope of the invention. For example, where the client is a software application, the client can have a “terminate and stay resident” component that is operable to be in communication with server 24 for receiving messages when the application window has been closed. Similarly, where the client is a computing device, the client can have an agent that is operable to maintain communications with server 24 for receiving messages when the computing device is perceivably inactivated or turned off.

The first set of functionality might not present information to a user of the client via the display. For example, a fridge can be provided with a display serving marketing messages to the user thereof, the display not being operable to serve any purpose for the first set of functionality, the refrigeration of goods placed therein.

Server 24 can be operable to generate reports based on information stored in database 28. In an embodiment, server 24 records all transmissions of marketing messages in database 28, along with any information about clients 36 to which they were communicated and any feedback received. As a result, server 24 can either proactively or reactively (in response to a request) generate and present a report summarizing the statistics associated with one or more marketing messages or clients 36. These reports can be generated and presented either instantaneously, allowing a marketing entity to monitor the current up-to-the-minute progress of its efforts, or, alternatively, at a later time.

The client can be operable to log a number of statistics associated with the messages. The statistics that can be recorded include, but are not limited to:

the number of times a message was received,

the number of times a message was played,

the time during which a message was visible (i.e. not hidden by another application window),

any user interaction with the message, and

the time, either specific, summarized or total, that the client is active.

Further, the client can report this information back to the server, which, in turn, could record the information in the database.

Although the software client of FIG. 6 is shown with certain specificity, it is to be understood by those of skill in the art that any software application having a graphical user interface operable to present marketing messages can be employed.

The methods of FIGS. 7, 8, and 9 can be combined as required by a marketing entity.

Although the computing device client of FIG. 10 is shown being a mobile phone, it is to be understood by those of skill in the art that other computing devices, such as wireless email devices and personal digital assistants, can also be employed.

The above-described embodiments of the invention are intended to be examples of the present invention and alterations and modifications may be effected thereto, by those of skill in the art, without departing from the scope of the invention which is defined solely by the claims appended hereto.

We claim:

1. A marketing network system, comprising:
a server having storage means for storing at least one marketing message, at least one processor operable to generate at least one data transmission from said at least one marketing message, from a marketing entity, and a server network interface connected to a communications network and operable to transmit said at least one data transmission across said communications network; and
at least one client having a client network interface connected to said communications network, processing means and a display interface for displaying a graphical user interface (GUI), said at least one client providing a first set of functionality operable to display output information via said GUI, and a second set of functionality operable to receive said at least one data transmission from said server via said network interface, generate said at least one marketing message from said at least one data transmission and present said at least one marketing message to said user via at least a portion of said GUI.

2. The marketing network system of claim 1, wherein said marketing entity is a public company.

3. The marketing network system of claim 1, wherein said server is operable to selectively transmit said at least one marketing message to said client based on at least one message rule.

4. The marketing network system of claim 1, wherein at least one of said at least one message rule is at least partially based on a quota.

5. The marketing network system of claim 4, wherein said quota is at least partially based on the number of said messages transmitted to said client.

6. The marketing network system of claim 4, wherein said quota is at least partially based on the number of said messages transmitted to all of said clients.

7. The marketing network system of claim 3, wherein at least one of said at least one message rule is at least partially based on at least one pre-selected time period.

8. The marketing network system of claim 3, wherein at least one of said at least one message rule is at least partially based on the geographic location of said user.

9. The marketing network system of claim 3, wherein said server is operable to maintain a profile for said user of said client, wherein at least one of said at least one message rule is at least partially based on said profile, and wherein said profile is at least partially comprised of personal data provided by said user.

10. The marketing network system of claim 1, wherein said client is a software application.

11. The marketing network system of claim 10, wherein said software application is freeware.

12. The marketing network system of claim 1, wherein said client is a computing device.

13. The marketing network system of claim 1, wherein said server is operable to detect a communication limitation of said client network interface and said communications network and selectively adjust at least one of said at least one marketing message before generation of said at least one data communication.

14. The marketing network system of claim 1, wherein said server is operable to detect a display limitation associated with at least one of said GUI and said display interface of said client and selectively adjust at least one of said at least one marketing message before generation of said at least one data communication.

15. The marketing network system of claim 1, wherein said client additionally has an input interface and said at least one marketing message allows said user to provide feedback to said server via said client network interface, and wherein said server is operable to receive and record said feedback received from said client and selectively transmit said messages at least partially based on said feedback.

16. The marketing network system of claim 1, wherein said at least a portion of said GUI is a variable portion of said GUI.

17. The marketing network system of claim 16, wherein said variable portion of said GUI is controlled by said server.

18. A software client for providing a marketing network, comprising:
a graphical user interface (GUI) for presentation on a display associated with a computing device upon which said software client is executed, said GUI having a first display region and a second display region;
a first set of functionality being presented via said first display region of said GUI;
a network interface operable to receive data communications containing at least one marketing message from a marketing entity via a communications network connected to said computing device; and
a second set of functionality operable to receive said data communications, generate said at least one marketing message from said data communications and present said at least one marketing message in said second display region of said GUI.

19. The software client for providing a marketing network as claimed in claim 18, wherein said software client is freeware.

20. The software client for providing a marketing network as claimed in claim 18, additionally comprising:
an input interface operable to allow a user of said software client to interact with said second set of functionality, and
wherein at least one of said at least one marketing message allows said user to provide feedback via said network interface.

21. The software client for providing a marketing network as claimed in claim 18, wherein said second display region is a variable portion of said GUI.

22. The software client for providing a marketing network of claim 21, wherein said variable portion of said GUI is controlled by at least one of said at least one marketing message.

23. A server for operating a marketing network, comprising:
a central processing unit (CPU), a data storage device for exchanging non-volatile data with said CPU, random access memory (RAM) for exchanging volatile data with said CPU, and a network interface for sending and receiving data communications;
said network interface operable to receive at least one marketing message from at least one marketing entity;
said CPU and RAM operable to store said marketing messages in a message database; and
said CPU being operable to retrieve said at least one marketing message associated with one of said marketing entities from said database and transmit said at least one marketing message associated with one of said marketing entities via said network interface to at least one client associated with said one of said marketing entities.

24. The server for operating a marketing network of claim 23, wherein said network interface is operable to receive a set of rules associated with said at least one marketing message, wherein said CPU is operable to store said set of rules in said message database, wherein said CPU is operable to analyze said set of rules associated with said at least one marketing message, and wherein said CPU is operable to selectively direct said network interface to transmit said at least one marketing message to said at least one client associated with said one of said marketing entities based on said set of rules.

25. The server for operating a marketing network of claim 23, wherein said CPU is operable to receive client information associated with each of said at least one client via said network interface and is operable to store said client information in said database.

26. The server for operating a marketing network of claim 25, wherein said client information is at least partially comprised of personal data provided by a user of said client.

27. The server for operating a marketing network of claim 23, wherein said CPU is operable to receive feedback via said network interface from said at least one client, and wherein said CPU is operable to record said feedback received from said at least one client in said database.

28. The server for operating a marketing network of claim 23, wherein said CPU is operable to maintain client statistics in said database and generate a statistical report from said client statistics.

29. A method for providing a marketing network, comprising the steps of:
distributing a client having a display interface for displaying a graphical user interface (GUI), a network interface connected to a communications network and operable to receive data communications, and a processing means, said client providing a first set of functionality operable to display output information via said display interface and a second set of functionality operable to receive said data communications from said network interface, process said data communications via said processing means and present messages contained in said data communications via at least a portion of said GUI;
receiving at least one message from a marketing entity; and
communicating said data communications containing said messages from a marketing entity across said communications network to said client for presentation via said display interface.

30. The method for providing a marketing network of claim 29, wherein provision of said first set of functionality to said user is subsidized by said marketing entity providing said messages to said user via said second set of functionality.

31. The method for providing a marketing network of claim 29, additionally comprising, before said communicating step, the steps of:
receiving at least one rule associated with said messages; and
determining whether said client is to receive said messages based on said at least one rule.

32. The method for providing a marketing network of claim 31, wherein said at least one rule is at least partially based on a quota.

33. The method for providing a marketing network of claim 32, wherein said quota relates to the number of said messages transmitted to said client.

34. The method for providing a marketing network of claim 31, wherein said at least one rule is at least partially based on at least one pre-selected time period.

35. The method for providing a marketing network of claim 31, wherein said at least one rule is at least partially based on the geographic location of said client.

36. The method for providing a marketing network of claim 31, wherein said step of determining is at least partially comprised of comparing said at least one rule with a profile maintained for said client.

37. The method for providing a marketing network of claim 35, wherein said profile is at least partially comprised of personal data provided by said user.

38. The method for providing a marketing network of claim 29, wherein said client is a software client.

39. The method of providing a marketing network of claim 29, wherein said client is a computing device.

40. The method of providing a marketing network of claim 29, further comprising, before said communicating step, the steps of:
detecting a communication limitation of said network interface and said communications network; and
selectively adjusting said message for said communication limitation.

41. The method of providing a marketing network of claim 29, further comprising, before said communicating step, the steps of:
detecting a display limitation associated with at least one of said GUI and said display interface of said client; and
selectively adjusting said message for said display limitation.

42. The method of providing a marketing network of claim 29, wherein said client additionally has an input interface and at least one of said at least one message allows said user to provide feedback to said marketing entity via said network interface, and wherein said method further comprises, after said communicating step, the steps of:
receiving and recording said feedback from said user; and
selectively transmitting said data messages at least partially based on said feedback.
